(19) United States
(12) Patent Application Publication
(10) Pub. No.: US 2002/0029158 A1
(43) Pub. Date: Mar. 7, 2002

(54) Method and system for the life insurance industry

(76) Inventors: Stephen C. Wolff, Laguna Beach, CA (US); Ken Leisher, Costa Mesa, CA (US); Allan E. Lubitz, Irvine, CA (US); Michelle L. Sullivan, Costa Mesa, CA (US); Robert G. Gottesman, Studio City, CA (US); Bruce A. Hoffman, Irvine, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/746,080

(22) Filed: Dec. 22, 2000

Related U.S. Application Data
(60) Provisional application No. 60/172,114, filed on Dec. 23, 1999.

(51) Int. Cl. G06F 17/60

(52) U.S. Cl. 705/4; 705/37

(57) ABSTRACT

A method for the life insurance industry in which an insurance policy request initiator initiates the creation of an Insurability Documentation File that contains the information needed by underwriters or insurers to evaluate the insurability rating of the prospective insured party. The Insurability Documentation File is created by assembling, in electronic form, the Insurability Documentation from one or more Service Providers.

The single Insurability Documentation File in conjunction with a Universal Bid Request is submitted to one or more insurers for evaluation of the rating of the proposed life insurance policy. This collection of the expected insurability information into a single electronic file allows for more rapid and efficient handling and evaluation. The insurers may then respond to the Universal Bid Request with an insurability rating bid, which may be used by the prospective insured party to select an insurer for issuing a policy. Additional rounds of bidding by the same or different insurers may occur to increase the likelihood of the prospective insurer to find an insurance policy that fits his or her needs.

### PRIORITY CLAIM

This application claims the benefit of U.S. Provisional Application No. 60/172,114 filed Dec 23, 1999.

### FIELD OF THE INVENTION

The present invention relates to improved methods and systems for use in the life insurance industry, and more specifically, methods and systems for providing life insurance coverage and obtaining underwriting decisions from multiple life insurance carriers or reinsurers. These underwriting decisions relate to the ratings of insurability of prospective insured parties.

### BACKGROUND OF THE INVENTION

The $2.6 trillion life insurance industry is an immense industry that has developed a complex and widespread distribution and processing infrastructure. Multiple tiers of agents and wholesalers working within a network of insurance providers and re-insurers have evolved. These agents, wholesalers, insurers and re-insurers have further relied upon a network of ancillary service providers who provide the insurer with services such as access to copies of medical records and other data required to assess the insurability of the prospective insured party. This complex multiplicity of actors has been able to survive because of the fairly high margins formerly available in the insurance industry and the opacity of the industry to the average consumer. For most permanent life insurance products, such as Universal Life or Whole-Life insurance, very few consumers are able to adequately perform comparisons, due to the practical difficulties inherent in applying for multiple policies and providing each insurer the copies of medical records and other information that are necessary parts of the insurance pricing method used by the individual insurer. Consequently, there is inconsistent market pressure on individual insurers within the market. Further, the delays inherent in the traditional method of assembling required insurance documentation results in lost business due to abandoned inquiries from prospective insured parties.

However, with the deregulation of the financial services market, greater competition is entering the insurance market. The growing popularity of term life insurance, which is less dependent in its price structure on the detailed medical histories and other information that is used in the permanent life insurance industry, has further placed pressure on the permanent life insurance industry to develop more efficient and cost effective system and methods for distribution. This effect has only intensified as the number of term life insurance carriers who use modem communications methods such as the Internet to attract and interact with potential purchasers of insurance increases.

The underwriting process, i.e. the process of assessing the insurability of a prospective insured party, has been plagued by unpredictable and potentially long delays, as well as cost inefficiencies. In traditional systems it can take several months to collect all of the expected information and to perform an insurability assessment of the prospective insured party.

Traditionally, the customer interested in the purchase of a permanent life insurance policy, such as Universal Life or Whole-Life insurance would approach an insurance agent or retailer with a request to seek a policy. The agent/retailer would gather the basic information from the customer and have the customer provide a basic overview of the customer's medical history, the list of health care providers seen by the customer, and an authorization from the customer for the health care providers to release the information. The agent, if he does not do sufficient volume to support a contractual relationship with insurance carriers, would typically submit this request to a wholesaler (this term incorporates General Agents, Brokerages and other such intermediary organizations). The wholesaler works as a clearinghouse for smaller agents with a specified set of insurance providers. Some agents will submit this information to the insurer without relying on a wholesaler.

The wholesaler or agent would submit the request to one, or possibly more, insurers with which there is a pre-existing business relationship. The insurer must then gather the required support documentation concerning the prospective insured party that is needed to evaluate the advisability of issuing a policy and a rating of the potential insured party.

Each insurance company, or carrier, relies on a network of wholesalers and/or service providers, such as copying services that go to remote locations and copy medical, financial and other required records upon request. With these records, medical examination reports, and other verifications, the insurance carrier reviews the information required to perform a risk assessment on a policy. The process can result in an inefficient duplication of services, in that service providers are often tasked to provide the same records to multiple insurers, only one of which, typically, will actually issue the policy. This process of document collection can be time-consuming and complex with innumerable possible delays caused by scheduling, communication, or procedural errors. Often the process of providing an underwriting decision may be delayed because of the lack of a single piece of information. However, there is little visibility to the consumer, the retailer, or to the wholesaler as to the status of the collection of the required information, and the source of any delay.

After an insurance carrier makes their underwriting decision, they provide a rating of the prospective insured party to the wholesaler or retailer, who in turn provides their customer with recommended insurance products and their related costs.

To receive underwriting decisions from multiple insurers, each insurer and/or wholesaler would have to replicate the activities of the others in the time consuming process of gathering together all of the information necessary to process the insurance application. This can require multiple service providers to provide duplicate information to each of the insurers, and each insurer is likely to encounter independent processing delays, which would make the receipt of multiple, timely insurance policy quotes unlikely. Further, this multiple copying of medical records by multiple service providers increases the likelihood that the confidential nature of the medical information of an applicant may be compromised simply due to the large number of times that it must be copied.

More typically, the retailer or wholesaler routes the policy to the insurance carrier based on other business criteria, or based on a subjective impression of which carrier is likely to provide the most favorable rating for the customer. Little opportunity to price compare exists.

Insurance carriers frequently seek to spread the risk inherent in the issuance of insurance policies by working with re-insurers. Carriers will shop individual policies or group together portfolios of policies and attempt to interest the reinsurer in further underwriting the group of policies, thereby spreading the risk. In the reinsurance market, the primary insurance carrier is faced with the many of the same hurdles in terms of the impediments to efficient provision of the information needed by reinsurers to evaluate the portfolio of insurance policies offered by the insurer.

### SUMMARY OF THE INVENTION

The preferred embodiment of the present invention provides a method and system for directly enhancing competition and efficient distribution in the life insurance industry. In the system, an initiator, typically the insurance agent or wholesaler, is provided with an efficient ability to solicit insurability rating bids from a substantial number of insurance carriers. The agent and his/her customer are then in a position to consider and choose the insurer providing the best rating and best product. Additional rounds of bidding may be initiated, if it is believed by the initiator, that it would be beneficial. Rounds of bidding after the first may, optionally, be supplemented by providing insurance carriers information concerning what bids were made by bidders in the previous rounds.

The ability to have multiple carriers bid for the insurance customer's business is enabled by the creation of a single insurability documentation file and a Universal Bid Request. In the preferred embodiment, a single system, such as FlashFlow^{SM} by Flashunderwriting.com, is used to aggregate the information and documentation relating to the evaluation of the insurability of a prospective insured party that is generally expected by an insurance carrier. Additionally a Universal Bid Request (UBR), such as that created by FlashUnderwriting.com allows agents and wholesalers to submit requests for insurance quotes to multiple carriers utilizing the same form. The Universal Bid Request supplies basic health data for, and a transferable medical information release from, the prospective insured party. This Universal Bid Request eliminates the need for multiple signatures from the prospective insured party on the proprietary forms of each individual insurer. A feature of the preferred embodiment of the invention is an optical imaging network and broadband digital storage system connecting life insurance agents, insurance wholesalers, underwriters and reinsurers for facilitating the very rapid, yet private and secured communication over private or public networks such as the World Wide Web, of all of the information needed for obtaining underwriting decisions from the insurance companies, within a centralized insurance file assembly system.

The documentation used to evaluate the insurability of the prospective insured party, such as the results of the medical exam of the applicant, the medical history of the applicant, and other required reports are sent by the service providers, health care providers, and/or other originating points to the centralized insurance file assembly system. This is done in a secure manner and the data is kept within the centralized insurance file assembly system in a secure manner, due to the confidential nature of the material. In the preferred embodiment of the invention, these are sent via an electronic communications network, such as the Internet, and are in the form of electronic documents in Adobe Portable Document Format (PDF). However, in other embodiments these may be sent as electronic documents in other digital formats, e.g. TIFF, or as facsimile transmissions, or other means, including physical copies of the original documents. When the reports are sent as physical copies, the copies are then digitized to produce electronic copies of the documents at the central collection site. This provides advantages in both speed of handling and information security over the prior art methods. After each input document is scanned, either by a third party such as a service provider or within the centralized insurance file assembly system, the documents are assembled electronically and transferred electronically to those evaluating the insurability of the prospective insured party, resulting in much greater speed of processing and handling. Further, each confidential record of the customer is only digitized once, and the security risks inherent in the proliferation of copies of these records by multiple copy services are avoided. The use of a single secure collection site allows for more complete and verifiably secure storage of the client's confidential information. Additionally, the electronic insurability documentation file may readily be transferred to third parties performing the assessment of the insurability of the prospective insured party on behalf of the insurance provider. In this manner, the assessment process may be decentralized and is no longer tied exclusively to the location of the physical insurability documentation (an example would be home-based underwriting).

In the preferred embodiment of the invention, the digitized electronic document is divided into standard sections containing particular content and these sections are indexed within the electronic document. In the preferred embodiment this is achieved using document structuring capabilities inherent in the Portable Document Format (PDF). In other embodiments, this may be performed by utilizing bookmarking and chapter identification methods particular to the format. In still other embodiments, there may be no internal structure to the digital document. In the preferred embodiment each section has a cover page containing information about the section and identifying the prospective insured party in a machine-readable format, such as a bar code. This cover page may be added to each report or section by the originator of the document, or may be added at the collection site.

In one feature of the preferred embodiment, the central collection site tracks the status of the insurability documentation for the prospective insured party. The customer, agent, or wholesaler may track the status of the assembly of the documentation via a secure World Wide Web connection over the Internet to the web site of the insurance file assembly system.

Upon completion of collecting the material and the creation of the insurability documentation file, the file is electronically transmitted over an encrypted or otherwise secure network to participating insurance companies or to other underwriting entities designated by the insurance companies to evaluate the insurability of the prospective insured party. In some embodiments, the insurability documentation file may be customized to only include those sections of the file required by that insurance carrier, to have the sections in a different order, or to be in a different form.

In turn, the solicited insurance carrier or their designee rates the prospective insured party and communicates this rating bid to the policy request initiator. The client, or authorized initiator may accept the insurability rating of one of the insurance providers or, alternatively, a second round of bidding from the same or other participating insurance carriers may be initiated. The second round of bids is received in the same manner as the initial round of bids. In alternative embodiments, more rounds of bidding are performed.

Upon the acceptance of a bid by the customer, authorized agent, or authorized wholesaler, the customer or his representative will prepare the official approved insurance application form and submit it to the selected insurance carrier. In the preferred embodiment of the invention, this application may be downloaded from a web site associated with the centralized insurance file assembly system.

Before or after a life insurance policy has been issued by an insurer, the insurer may use the information contained in the insurability documentation files to support the reinsurance process. In the preferred embodiment, the insurer will utilize the centralized insurance management system to aggregate the information found in one or more insurability document files, into an electronic document which can be accessed by one or more reinsurers in order to evaluate a policy or portfolio of policies submitted for prospective reinsurance. In the preferred embodiment, the insurability documentation will have been previously aggregated as an insurability documentation file during the process of evaluation for primary insurance. However, the capability also exists to process insurability documentation not already converted into insurability document files. The aggregation of the insurability information associated with one or more insurance policies within a comprehensive reinsurance evaluation file allows for more rapid and simpler analyses of the insurance policies by re-insurers, than is available in traditional reinsurance practice, which relies on hard copies of records or multiple different electronic formats for the records and reports associated with the life insurance policies. In alternative embodiments of the invention, the insurers may offer portfolios of policies for bid by re-insurers in one or more rounds of bidding analogous to the rounds of bidding performed by the insurance companies in the process of offering the original life insurance policy.

### BRIEF DESCRIPTION 0F THE DRAWINGS

These and other features will now be described with reference to the drawings summarized below. These drawings and the associated description are provided to illustrate a preferred embodiment of the invention, and not to limit the scope of the invention.

FIG. 1 illustrates the interactions that would be required between participants in securing multiple life insurance ratings in a system utilizing the prior art.

FIG. 2 illustrates the interactions that would be required between participants in soliciting first insurability ratings in one embodiment of the invention.

FIG. 3 illustrates the flow of information between participants for the solicitation of insurability rating bids in one embodiment of the invention.

FIG. 4 illustrates the basic steps in creation of the insurability documentation file in one embodiment of the invention.

FIG. 5 illustrates the flow of information between participants in the creation of an insurability documentation file in one embodiment of the invention.

FIG. 6 illustrates an exemplary customer background information sheet to be filled out by the customer used in the creation of a Universal Bid Request.

FIG. 7 illustrates an exemplary Assignable Authorization to Obtain Medical Information release form to be filled out by the prospective insured party to facilitate the creation of a Universal Bid Request.

FIG. 8 illustrates an exemplary Medical History Questionnaire to be filled out by the life insurance customer or their agent for use in the generation of the Universal Bid Request.

FIG. 9 illustrates the exchange of information between participants in the solicitation of initial insurability rating bids, a second bidding round, and the preparation of the life insurance policy application in one embodiment of the invention.

FIG. 10 illustrates the exchange of information between participants in the process of soliciting bids for reinsurance.

### DETAILED DESCRIPTION OF THE PREFERRED EMBODIMENT

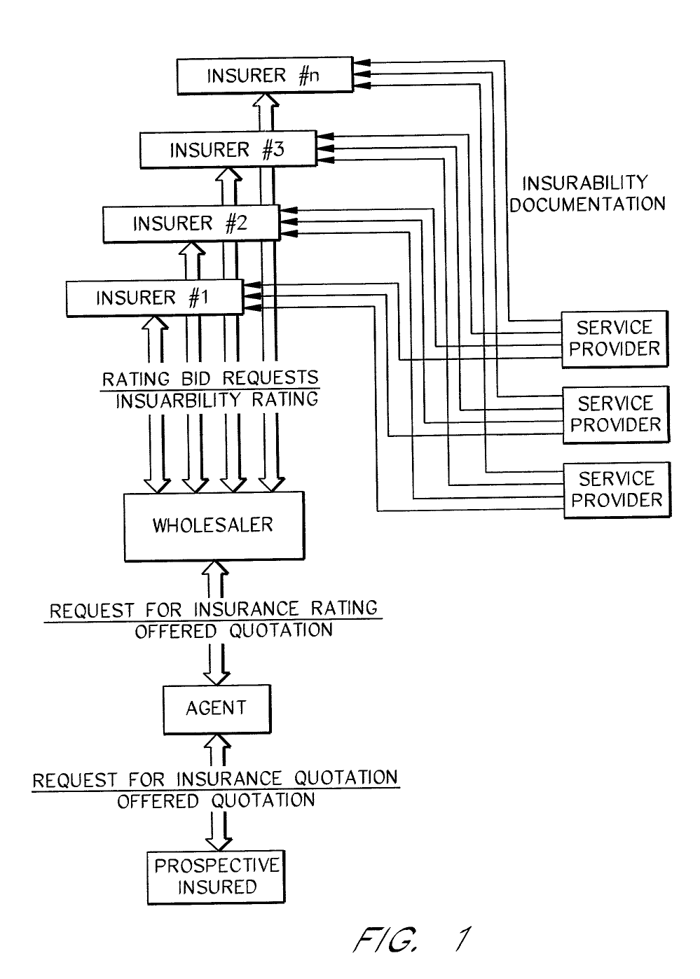

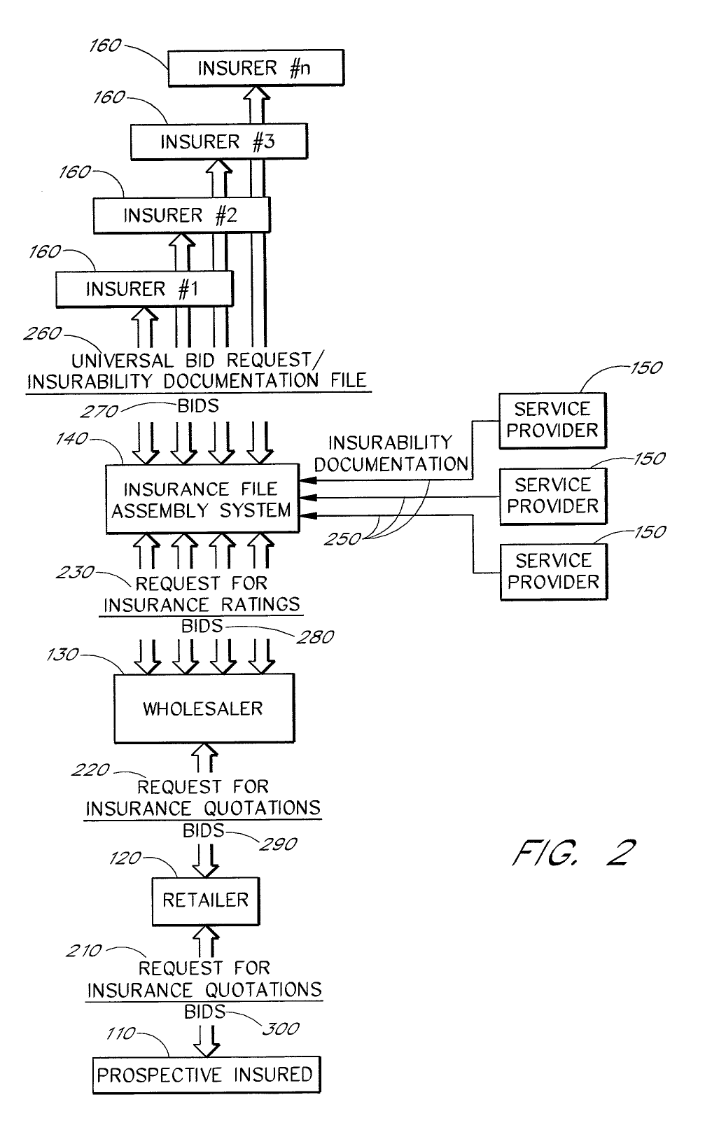

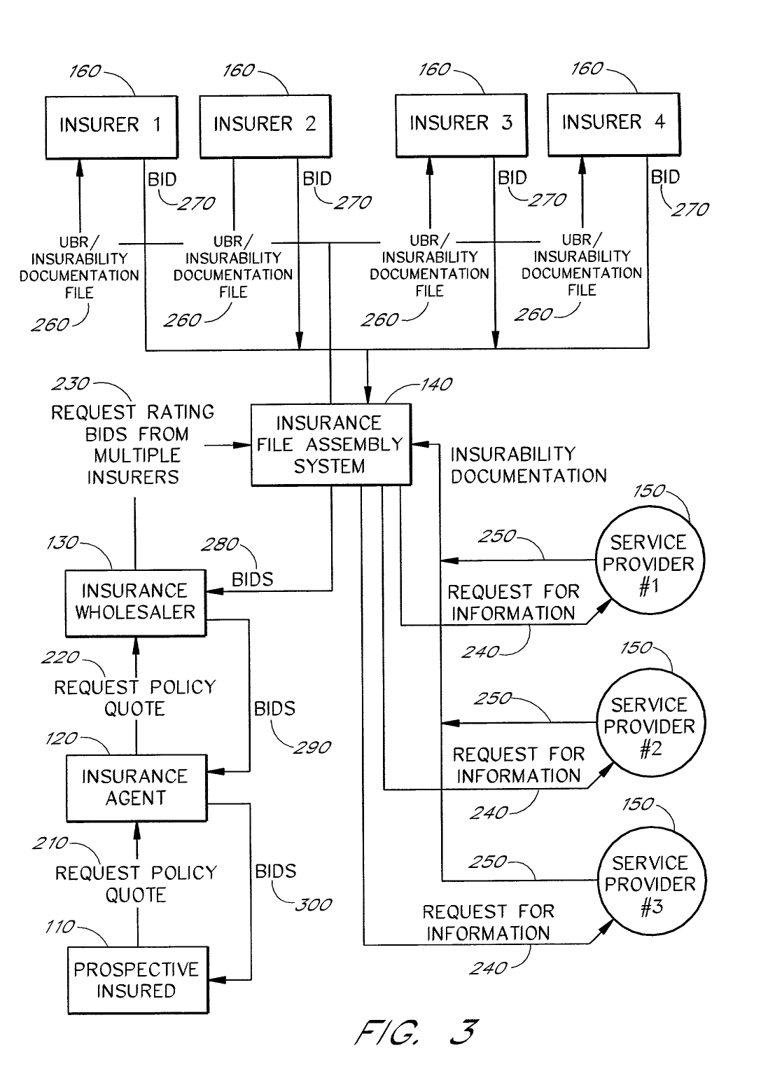

The preferred embodiment of the invention provides a substantially improved method for obtaining a life insurance underwriting decision by reaching multiple insurance carriers. This is achieved by the introduction of an Insurance File Assembly System and the use of Universal Bid Requests. The need for less coordination between multiple insurers 160 and the service providers 150 of insurability documentation 250 concerning the prospective insured party 110 is illustrated in FIG. 2. As shown in FIG. 2, a common Insurability Documentation File and Universal Bid Request 260 at a centralized Insurance File Assembly System 140 eliminates the need of each insurer to coordinate with multiple providers of insurability documentation. So as a result, the preferred embodiment requires less coordination of information transfer between multiple participants than in prior systems illustrated in FIG. 1

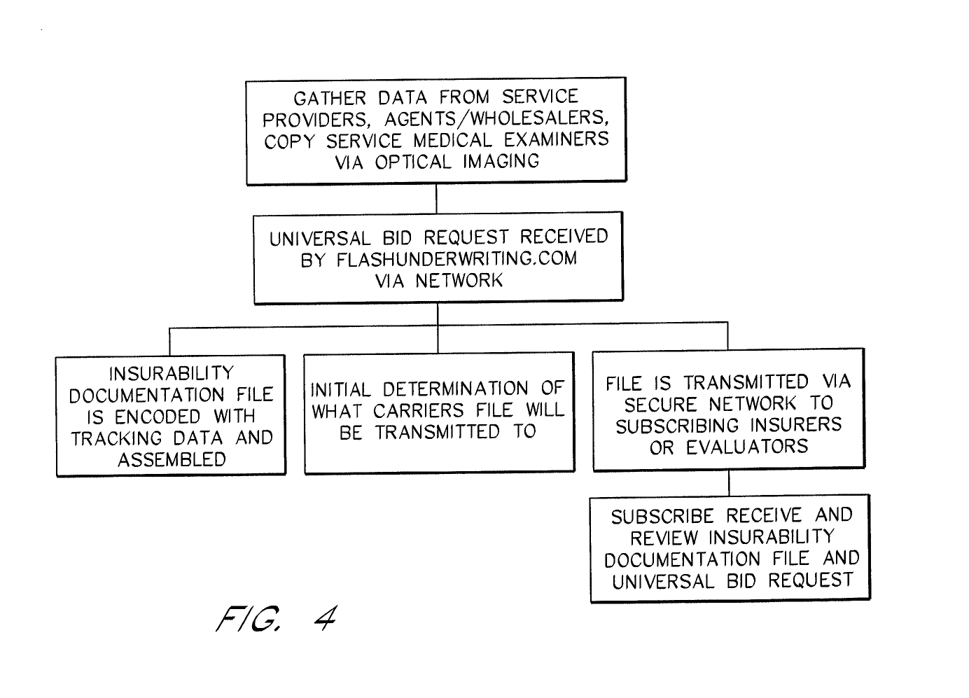

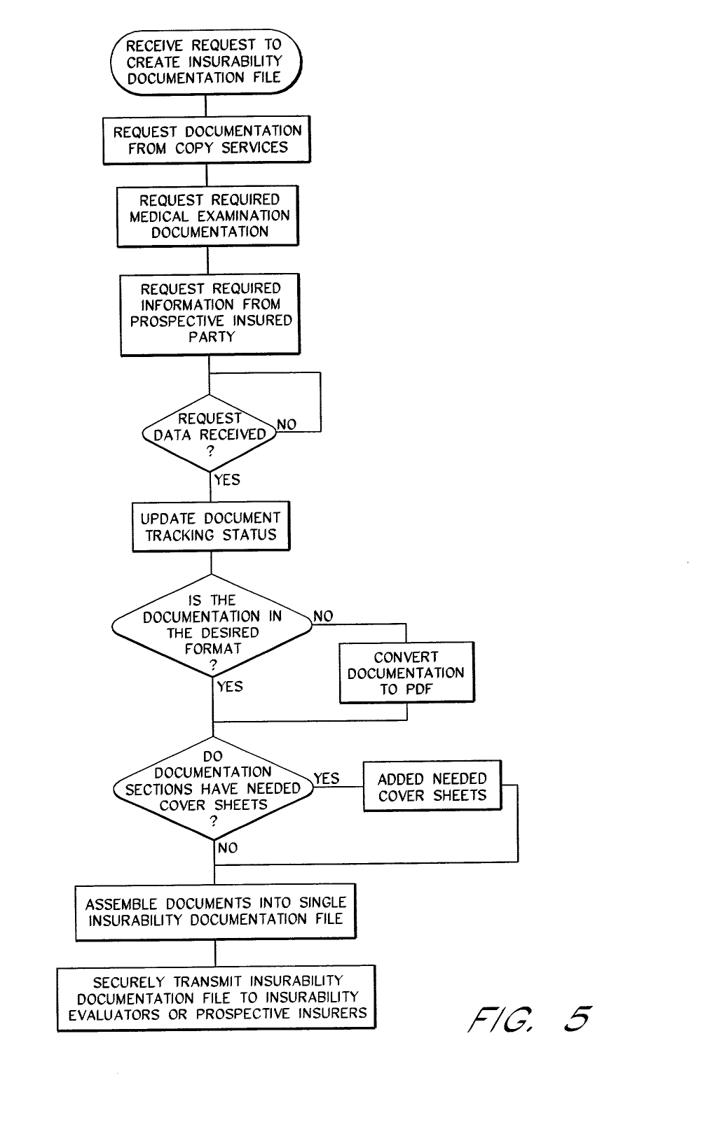

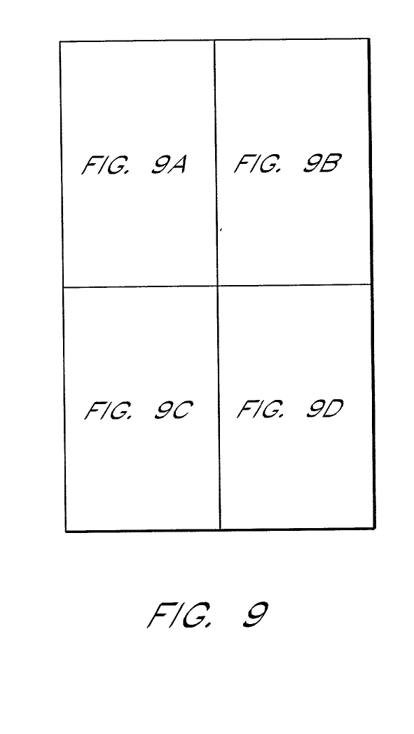

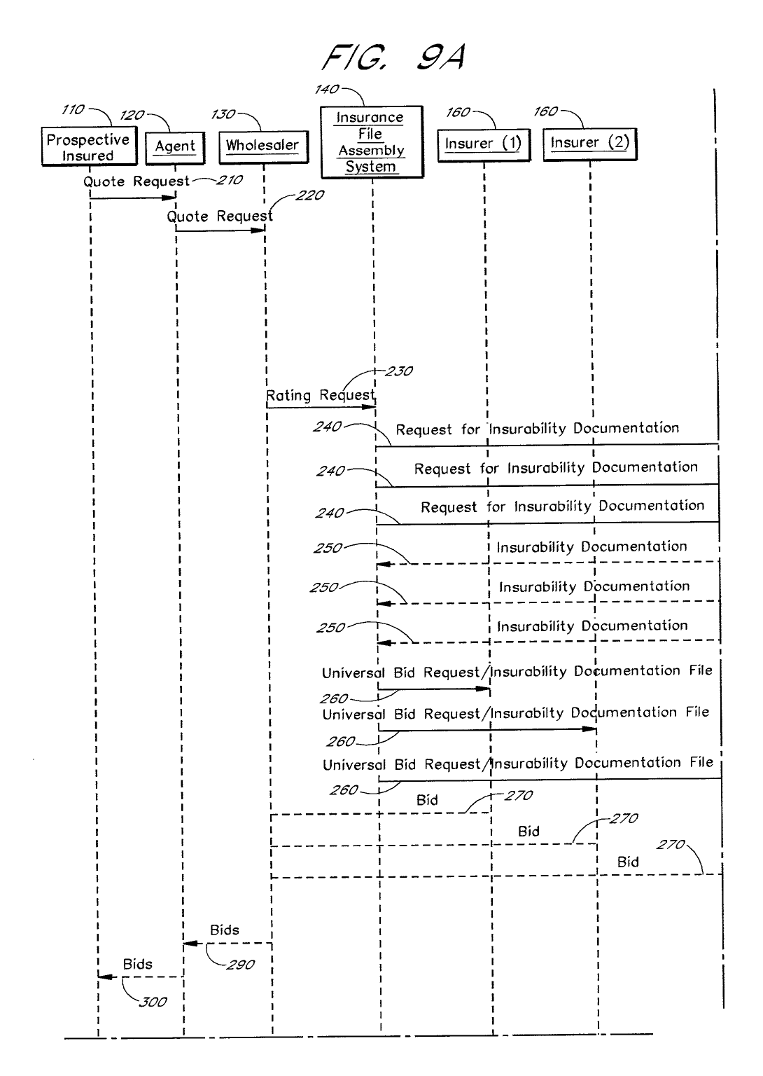

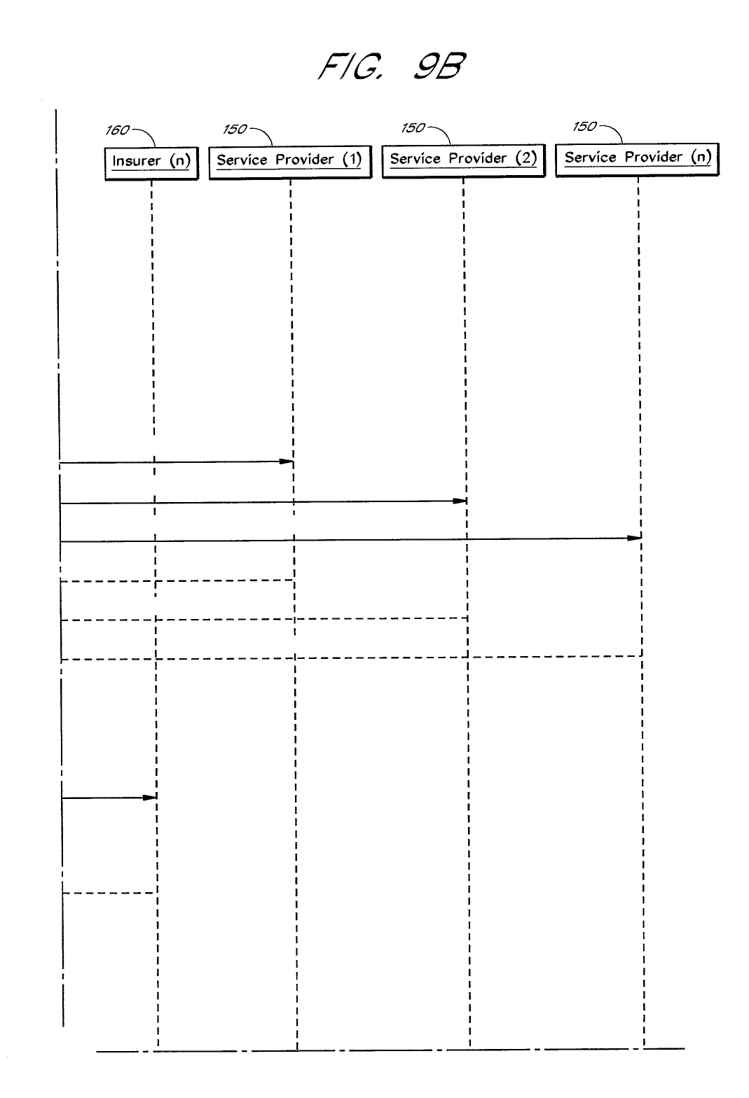

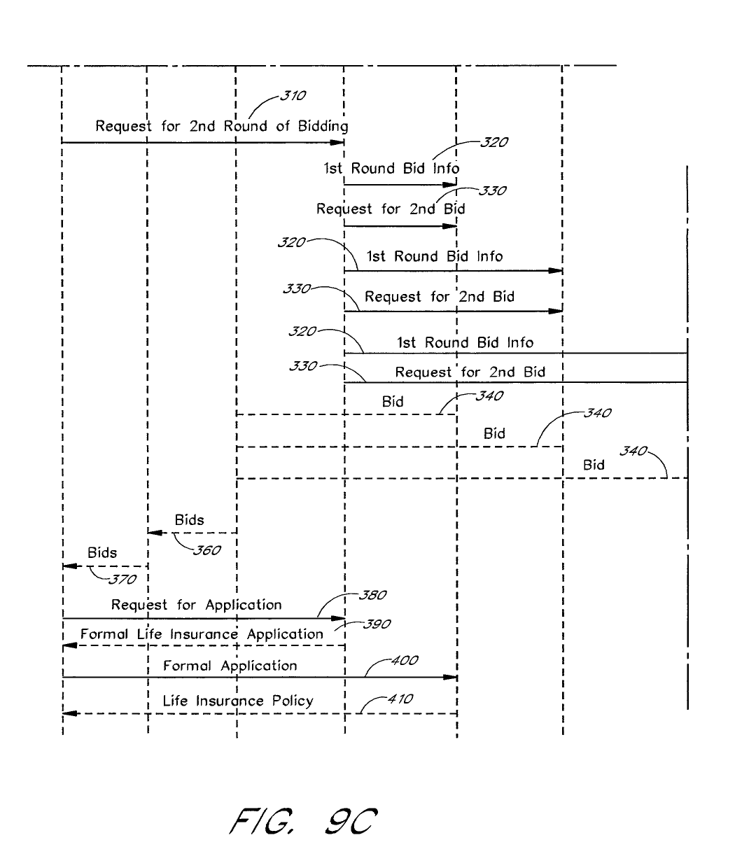

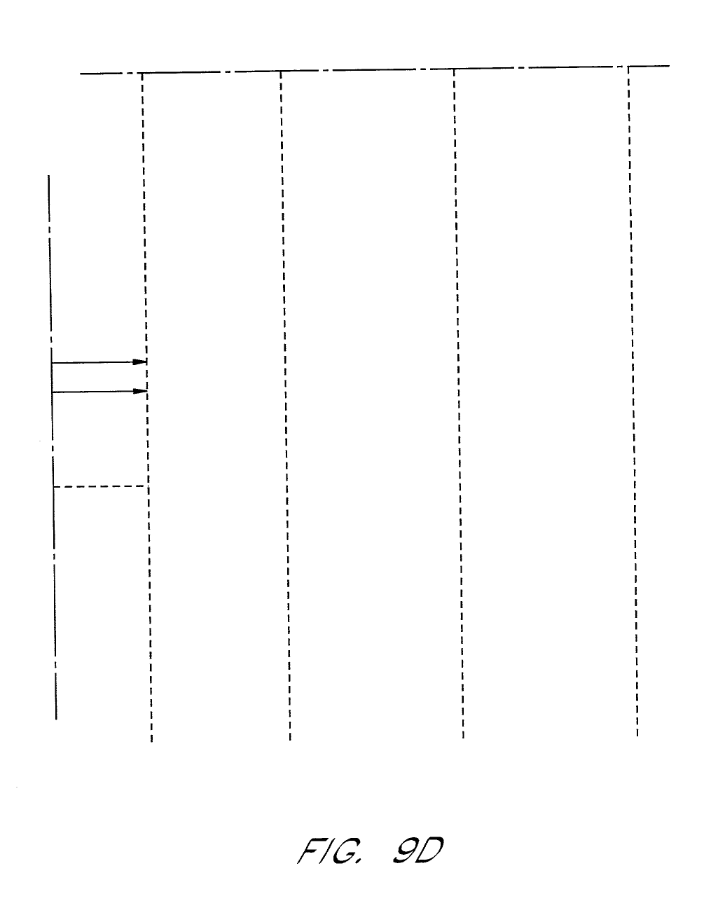

The process of initiating and receiving the initial bids is illustrated in FIGS. 3 and 9. The process is initiated when the prospective insured party 110 requests an insurance quotation 210 from an insurance agent 120. The agent requests an insurance rating quote 220 from a wholesaler 230. The wholesaler then issues a request for insurance ratings from multiple insurers 230 by utilizing the Insurance File Assembly System 140. In the preferred embodiment the insurance wholesaler initiates the creation of an Insurability Documentation File, however in alternatives the process is initiated by an insurance agent 120 or the prospective insured party 110. Service providers 150, such as record copy services, medical exam services, and other information providers transmit Insurability Documentation 250 to the Insurance File Assembly System 140. From the multiple instances of Insurability Documentation 250, the Insurance File Assembly System 140 creates the Insurability Documentation File and the Universal Bid Request 260, that is created by the Agent and submitted to allow entities to obtain medical and other information, which are transmitted to the insurers 160. The Insurability Documentation File and the Universal Bid Request 260 provide sufficient information for the insurers 160 or their designated evaluators to rate the insurability of the prospective insured party 110. These ratings bids 270, 280, 290 are returned to the initiator of the request for insurance quotation. These ratings determine the quotation amount associated with the possible insurance policy. The product and pricing recommendations are given to the prospective insured party 110. At this point the prospective insured party may accept one of the quotations and apply for an insurance policy with the associated insurance provider. Alternatively, the prospective insured party 110, or an authorized agent 120, or wholesaler 130 may solicit an additional round of insurability ratings bids as shown in FIG. 9. This is performed by requesting a second round of bids 310. The second bid requests 330 are sent to various participating insurers 160, optionally information concerning the ratings bids provided by bidders in previous rounds may be provided to the prospective bidders in subsequent rounds, in some embodiments of the invention. Just as in the first round of bidding, ratings bids received from the insurance providers are transmitted to the initiator of the bid request. Additional subsequent rounds of bidding may be initiated.

When the prospective insured party 110, or their authorized agent 120, or wholesaler 130 selects an insurer 160, a request for an insurance application will be issued 380, received 390, and filed 400, resulting in the issuance of a life insurance policy 410.

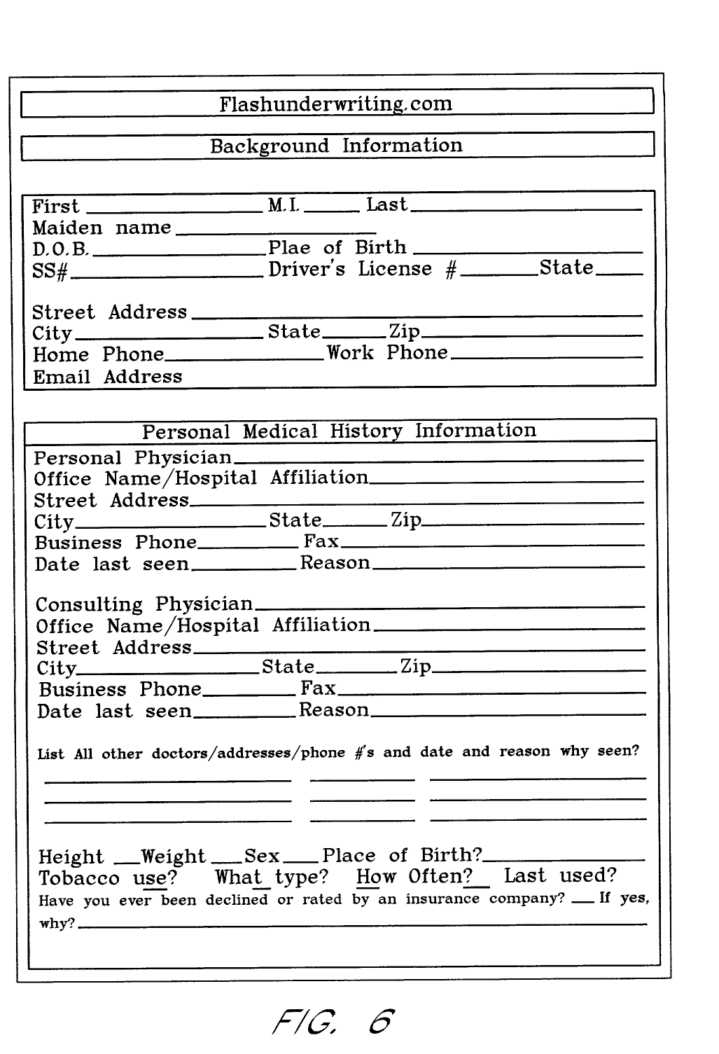

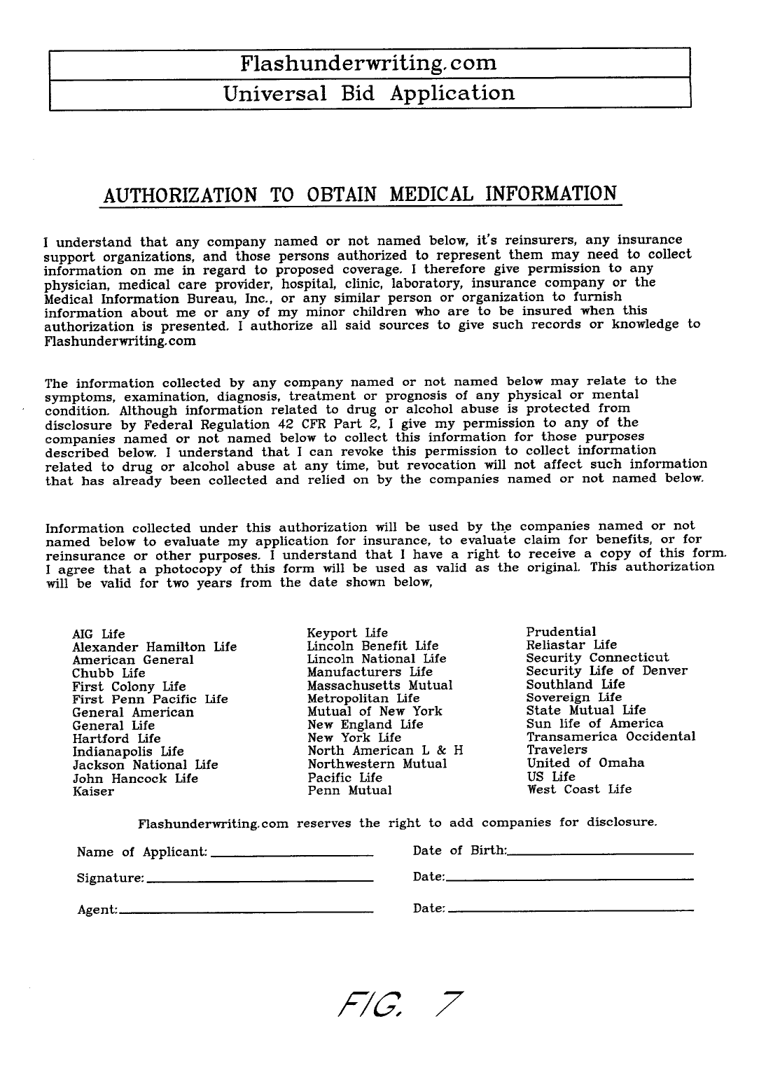

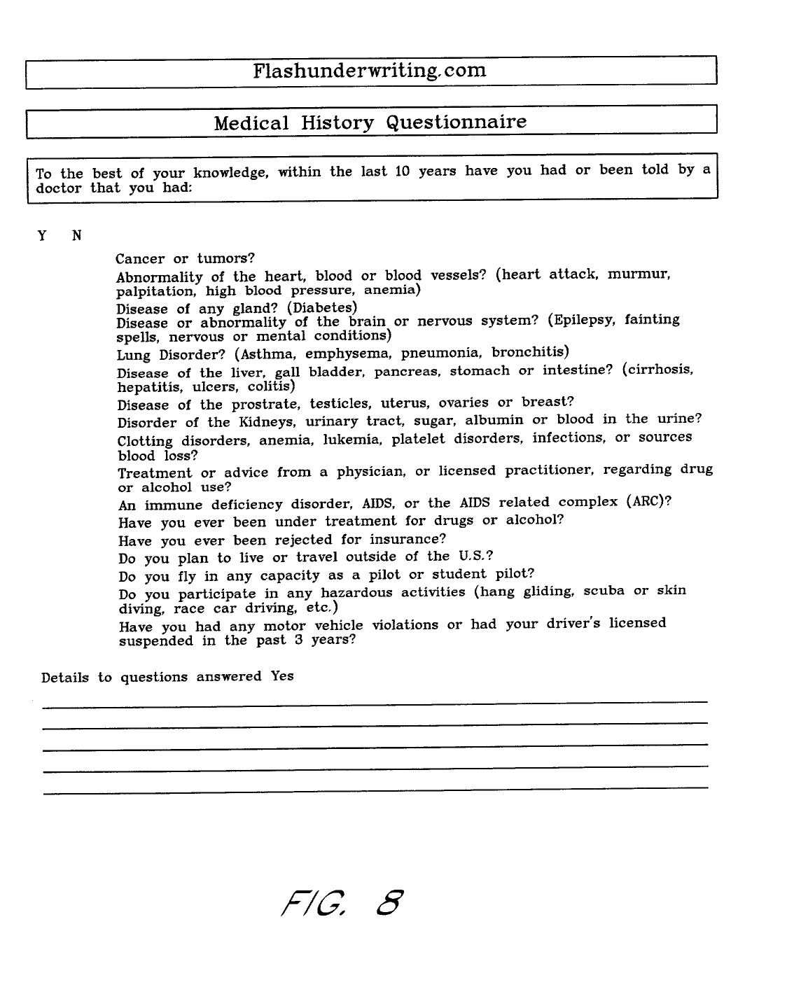

FIGS. 4 and 5 illustrate the steps involved in developing the Insurability Documentation File and the Universal Bid Request that is used to support the underwriting process used in soliciting ratings bids from insurers. The steps include gathering data from service providers and others to produce the Insurability Documentation File and Background Information, FIG. 6, an Assignable Medical Information Release Authorization, FIG. 7, and Medical History Questionnaire, FIG. 8, from the prospective insured party to produce the Universal Bid Request. Documentation may be received electronically, as a digital document or via facsimile transmission, or may be received via mail or other form of physical delivery of hard copy. In the preferred embodiment, a digital document is received via a secure computer network connection. As required documentation is received, the status of the needed documentation is updated in the system so that authorized parties may monitor the status of the documentation gathering via a secure status web page on the Internet. As data is received if it is not in the desired PDF format, such as TIFF or other digital format, the documentation will be converted into the PDF format. This may include the necessity of digitizing the documentation, if it has been received as a hard copy, or it may merely require a format conversion to PDF format. If the document was not received with the required cover sheets for separating and identifying the various sections of the document, these must be added. The insurability documentation is assembled into a single complete Insurability Documentation File. This file is then transferred in digital form to the Insurance Providers or their designated underwriters via a secure computer network.

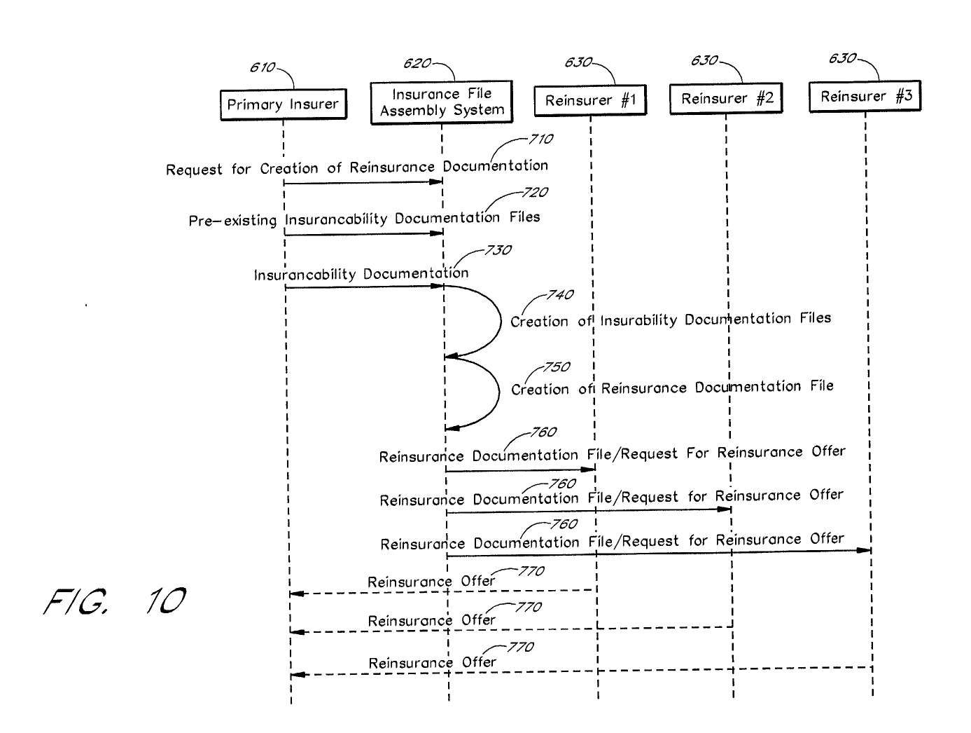

An embodiment of the system allows Primary Insurers to make their interactions with Reinsurers more efficient and streamlined as shown in FIG. 10. A Primary Insurer 610 will initiate the creation of a Reinsurance Documentation File 710 for a single policy or portfolio of insurance policies from an Insurance File Assembly System 630. This can include some combination of pre-existing Insurability Documentation Files 720 with Insurability Documents in other forms 730. In the preferred embodiment this is performed by converting the Insurability Documents 730 into a new set of Insurability Documentation Files 740, which are combined with the pre-existing Insurability Documentation Files to create a Reinsurance Documentation File 750. The Reinsurance Documentation File is transmitted to the Reinsurers 630, for evaluation accompanied by a request for a reinsurance offer 760 via a secure network connection. The reinsurer 630 now assesses the insurability information of the policies making up the submitted portfolio. Based on this they make a Reinsurance Offer 710 to the Primary Insurer 610. In this manner the Primary Insurer and the Reinsurers increase the efficiency and decrease the time required to evaluate the submitted insurance policy portfolio and to make an offer for reinsurance.

What is claimed is:

1. A method to improve the efficiency of the life insurance sales process comprising:
initiating the creation of an insurability documentation file in a centralized insurance file assembly system for a possible life insurance policy concerning a prospective insured party by an insurance policy request initiator;
receiving, at the centralized insurance file assembly system, from one or more information sources, information and documentation concerning the prospective insured party, said information and documentation being that which is expected by insurance providers to allow assessment of the insurability of the prospective insured party;
creating the insurability documentation file at the centralized insurance file assembly system, said insurability documentation file being a single digital document containing the information and documentation concerning the prospective insured;
securely transmitting the insurability documentation file from the centralized insurance file assembly system to a first set of one or more evaluators of the insurability of the prospective insured party.

2. The method of claim 1 further comprising:
receiving from each member of the first set of one or more evaluators of the insurability of the prospective insured party, a first bid of the insurability rating of the prospective insured party;
transmitting securely to a second set of one or more evaluators of the insurability of the prospective insured party, the insurability documentation file;
soliciting from each member of the second set of one or more evaluators of the insurability of the prospective insured party, a second bid of the insurability rating of the prospective insured party.

3. The method of claim 2, further comprising transmitting to the second set of one or more evaluators, the first bid received from one or more members of the first set of one ore more evaluators of the insurability of the prospective insured party.

4. The method of claim 1, wherein at least a portion of the information and documentation concerning the prospective insured party is received at the centralized insurance file assembly system as digital files.

5. The method of claim 4, wherein the digital files are received at the centralized insurance file assembly system via an electronic computer communications network.

6. The method of claim 1, wherein the secure transmission from the centralized insurance file assembly system of the insurability documentation file is via an electronic computer communications network.

7. The method of claim 1, wherein the insurability documentation file has an internal structure corresponding to the subject matter of the information and documentation concerning the prospective insured.

8. The method of claim 1, wherein at least a portion of the information and documentation concerning the prospective insured party is received at the centralized insurance file assembly system as physical documents and is converted to digitized files by the centralized insurance file assembly system

9. The method of claim 1, wherein at least a portion of the information and documentation concerning the prospective insured party is received at the centralized insurance file assembly system as a facsimile transmission.

10. The method of claim 1, wherein the insurance policy request initiator is a life insurance agent.

11. The method of claim 1, wherein the insurance policy request initiator is a life insurance wholesaler.

12. The method of claim 1, wherein the insurance policy request initiator is the prospective insured party.

13. The method of claim 1, wherein the insurance policy request initiator is an insurance broker.

14. A system for the life insurance industry comprising:
a central insurance file assembler to collect and assemble an insurability documentation file;
the insurance file assembler comprising one or more electronic computers, connected via a communications network, which assemble insurability documentation inputs into the insurability documentation file;
the insurability documentation file containing insurability documentation inputs about a prospective insured party expected by one or more insurability evaluator;
a first communications pathway to allow transmission of the insurability documentation inputs to the insurance file assembler from one or more input sources; and
a second communications pathway to allow the transmission of the single insurability documentation file to the one or more insurability evaluator.

15. The system of claim 14, wherein the first communications pathway is a first electronic computer communications network.

16. The system of claim 14, wherein the first communications pathway is a telephone facsimile communications connection.

17. The system of claim 14, wherein the first communications pathway is an optical imaging network.

18. The system of claim 14, wherein the second communications pathway is a second electronic computer communications network.

19. The system of claim 18, wherein the single insurability documentation file has an internal structure, said internal structure corresponding to the subject matter of the insurability documentation inputs of the insurability documentation file.

20. The system of claim 19, wherein the single insurability documentation file is in Adobe Portable Document Format (PDF).

21. A system for collecting and assembling an insurability documentation file comprising:
insurability documentation inputs about a prospective insured party expected by one or more insurability evaluators;
one or more electronic computers connected via a communications network to the insurability documentation inputs, the one or more electronic computers implementing assembly of the insurability documentation file; and
an electronic transmission network connecting the one or more electronic computers and one or more insurability evaluators.

22. The system of claim 21, wherein the insurability documentation file has an internal organization structure corresponding to the subject matter of the insurability documentation inputs.

23. The system of claim 22, wherein the communications network is the Internet.

24. The system of claim 23, wherein the insurability documentation file is in Adobe Portable Document Format (PDF).

25. A method of improving the efficiency of the life insurance industry comprising creating a single digital insurability documentation file, said file containing the information expected by a plurality of insurance rating evaluators for rating a prospective insured party.

26. A system for the life insurance industry comprising:
a central insurance file assembler to collect and assemble an insurability documentation file;
the insurance file assembler comprising one or more electronic computers, connected via a communications network, which assemble insurability documentation inputs into the insurability documentation file;
the insurability documentation file containing insurability documentation inputs about a prospective insured party expected by a plurality of insurability evaluators;
a first communications pathway to allow transmission of the insurability documentation inputs to the insurance file assembler from one or more input sources; and
a second communications pathway to allow the transmission of the single insurability documentation file to the one or more insurability evaluator.

27. The system of claim 26, wherein the first communications pathway is a first electronic computer communications network.

28. The system of claim 26, wherein the first communications pathway is a telephone facsimile communications connection.

29. The system of claim 26, wherein the first communications pathway is an optical imaging network.

30. The system of claim 26, wherein the second communications pathway is a second electronic computer communications network.

31. The system of claim 26, wherein the single insurability documentation file has an internal structure, said internal structure corresponding to the subject matter of the insurability documentation inputs of the insurability documentation file.

32. The system of claim 33, wherein the single insurability documentation file is in Adobe Portable Document Format (PDF).

33. A means for creating single insurability documentation file for a plurality of insurability evaluators from one or more insurability documentation inputs comprising:
a centralized assembly means for assembling the insurability documentation file;
a reception means for receiving the insurability documentation file inputs; and
a transmission means for transmitting the single insurability documentation file to the plurality of insurability evaluators.
